(19) United States
(12) Patent Application Publication
(10) Pub. No.: US 2025/0248330 A1
(43) Pub. Date: Aug. 7, 2025

(54) BLADE FOR LAWN MOWER

(71) Applicant: DAEDONG MOBILITY CORP., Anseong-si (KR)

(72) Inventor: Sang Ji Park, Jeonju-si (KR)

(73) Assignee: DAEDONG MOBILITY CORP., Anseong-si (KR)

(21) Appl. No.: 18/776,358

(22) Filed: Jul. 18, 2024

(30) Foreign Application Priority Data
Feb. 1, 2024 (KR) 10-2024-0015903

(51) Int. Cl. A01D 34/73; A01D 101/00

(52) U.S. Cl. CPC A01D 34/73; A01D 2101/00

(57) ABSTRACT

A lawn mower blade includes: a convex center part with a central hole formed where a bolt can be fastened from below; a curved part formed on both sides of the convex center part and bent downward; a blade body extending from both sides of the curved part; a side edge formed on the blade body with a sharp surface for cutting grass; and a lifting part formed by bending or folding a portion of the blade body to protrude to a certain height and create whirling wind.

### BACKGROUND OF THE INVENTION

### 1. Field of the Invention

The present invention relates to a blade for cutting grass, and more particularly to a blade with a shape that creates an air flow capable of lifting grass during blade rotation and easily moving cut grass upwards.

### 2. Description of the Related Art

Generally, lawn mowers are devices for cutting vegetation such as crops, grass, and young shrubs. Various types of lawn mowers have been proposed and widely used depending on their purpose and form.

In the past, grass cutting relied solely on manual tools like sickles, which required significant effort, took a long time, and had low work efficiency. Moreover, frequent accidents occurred during operation, such as hand cuts or even severed fingers due to the sharp blades.

As science advanced, agricultural machinery became mechanized. Notably, grass cutters were developed as attachments for agricultural machines like cultivators or power tillers. However, attaching grass cutters to cultivators or power tillers was labor-intensive and structurally complex, reducing their utility and leading to reluctance in use. This led to the development of riding grass cutters with built-in engines specifically for grass cutting operations. In particular, a riding grass cutter with an adjustable grass cutting device height was proposed in Japanese Patent Publication No. 5033151.

### SUMMARY OF THE INVENTION

The present invention aims to provide a blade for use in riding lawn mowers and the like, which can efficiently lift and cut flattened grass during blade rotation and create a favorable air flow for efficiently discharging cut grass upwards.

A lawn mower blade comprising: a convex center part with a central hole formed where a bolt can be fastened from below;

a curved part formed on both sides of the convex center part and bent downward; a blade body extending from both sides of the curved part; a side edge formed on the blade body with a sharp surface for cutting grass; and a lifting part formed by bending or folding a portion of the blade body to protrude to a certain height and create whirling wind.

And, wherein the blade has an origin-symmetrical shape with the central hole of the convex center part as the origin.

And, wherein when drawing an imaginary horizontal center line (D2) that equally divides the upper and lower parts of the blade based on the center of the central hole, and a vertical center line (D1) that equally divides the left and right sides of the blade, a bending line meaning the part where the lifting part is folded from the blade body is formed not parallel to the horizontal center line.

And, wherein when the blade is viewed in plan, the upper right of the central hole is defined as the R1 region, the lower right of the central hole as the R2 region, the upper left of the central hole as the L1 region, and the lower left of the central hole as the L2 region by the horizontal center line and vertical center line, the side groove and lifting part are formed in the R1 region and L2 region, and part of the lifting part is also formed in the R2 region and L1 region.

And, wherein among the inner surfaces of the side groove, a first inner surface is positioned at the same height as the blade body, and due to the bending of the lifting part, a second inner surface among the inner surfaces of the side groove is positioned slightly higher than the blade body.

The proposed blade shape with its lifting part effectively raises flattened grass while simultaneously creating a whirling wind that efficiently discharges cut grass upwards.

### BRIEF DESCRIPTION OF THE DRAWINGS

FIG. 1 is a diagram showing the blade of this embodiment coupled to a lawn mower.

FIG. 2 is a side view of the blade according to this embodiment.

FIG. 3 is a plan view of the blade according to this embodiment.

FIG. 4 is a perspective view of the blade according to this embodiment.

FIG. 5 is a partial view of the blade as seen from perspective A shown in FIG. 3.

FIG. 6 is a schematic diagram showing air movement caused by the lifting part in the blade of this embodiment.

### DETAILED DESCRIPTION OF THE INVENTION

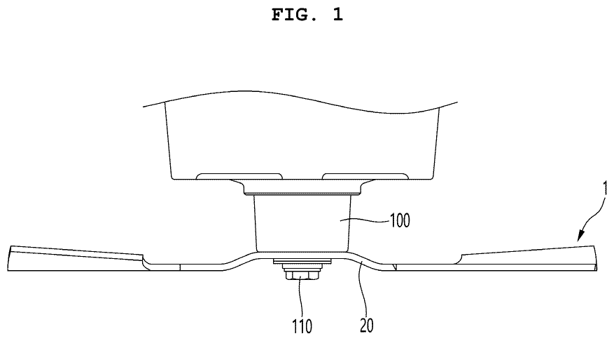

FIG. 1 is a diagram showing the blade of this embodiment coupled to a lawn mower.

Referring to FIG. 1, a lawn mower blade coupling part 100 protrudes downward from the bottom of a lawn mower, such as a riding lawn mower, for coupling with the blade 1. The blade 1 of the embodiment is coupled to the bottom of the lawn mower blade coupling part 100 by a bolt 110.

A rotating shaft driven by a motor or the like is configured inside the lawn mower blade coupling part 100, and the blade 1 is coupled to the rotating shaft so that it rotates together with the rotating shaft.

The blade 1 has an origin-symmetrical shape (Centrally symmetric shape) with the central hole 11 in the center part as the origin. The center part 10 is formed more convex than other parts to make it easier to fasten to the lawn mower blade coupling part 100 and to reduce cases where the bolt 110 head touches the ground and gets damaged.

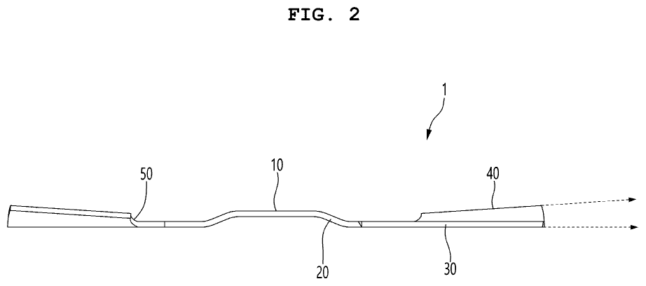

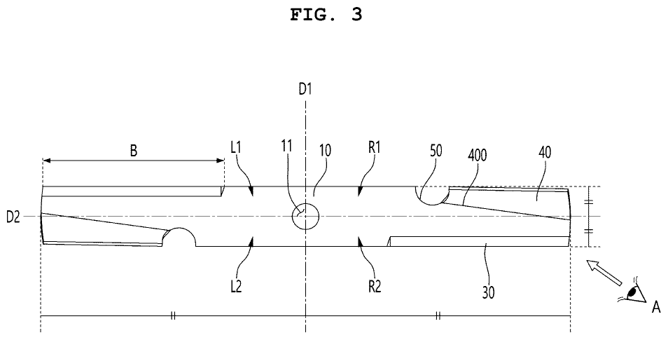

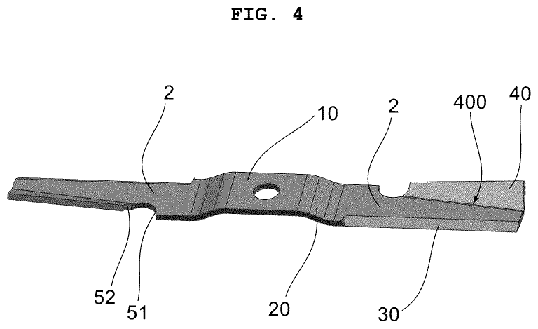

FIG. 2 is a side view of the blade according to this embodiment, and FIG. 3 is a plan view of the blade according to this embodiment. And, FIG. 4 is a perspective view of the blade according to this embodiment.

Referring to FIGS. 2 to 4, the blade 1 of the embodiment is formed in an overall shape close to a rectangle and includes: a convex center part 10 with a central hole 11 formed; curved part 20 formed on both sides of the convex center part 10 and bent downward; a blade body 2 extending from both sides of the curved part 20; side edge 30 formed on the blade body 2 with sharp surfaces for cutting grass; and lifting part 40 formed by bending or folding a portion of the blade body 2 to protrude to a certain height and create whirling wind.

The blade 1 of this embodiment has distinct characteristics in its various parts and overall shape. To facilitate a more precise description, the blade 1 is divided into four regions, as illustrated in FIG. 3. When viewed from above, these regions are defined relative to the center of the central hole 11 as follows:
R1: upper right quadrant
R2: lower right quadrant
L1: upper left quadrant
L2: lower left quadrant

This division allows for a more detailed explanation of the blade's features and their respective locations.

As previously mentioned, the blade 1 of this embodiment exhibits origin symmetry. Consequently, the R1 region mirrors the L2 region in shape, and the L1 region corresponds to the R2 region. This symmetrical design results in the following structural arrangement:
1. The side groove and lifting part are formed in both the R1 and L2 regions.
2. Portions of the lifting part extend into the R2 and L1 regions.

This symmetrical configuration ensures uniform performance and balance during the blade's operation.

The following description focuses on the blade's shape, particularly in the R1 region (upper right quadrant) and the R2 region (lower right quadrant) below it.

In the R1 region, a semicircular side groove 50 is formed. Adjacent to this side groove 50, a lifting part 40 is created by bending or folding a portion of the blade. This configuration results in a unique profile where some sections of the side groove's inner surface are level with the blade body 2, while others are elevated above it.

As illustrated in FIG. 4, this arrangement creates two distinct inner surfaces within the side groove 50: a first inner surface 51 that aligns with the height of the blade body 2, and a second inner surface 52 that rises above the blade body 2 due to the curvature of the lifting part 40.

The side groove 50, which can be characterized as a notch, serves a crucial function in the blade's design. It facilitates the smooth bending of the blade during the formation of the lifting part 40. The line along which the lifting part 40 is bent and folded (400, referred to as the bending line) is oriented diagonally across the blade.

A key feature of the blade's design is the orientation of the bending line 400. To understand this, we can consider two imaginary lines:
1. A horizontal center line (D2) that equally divides the blade into upper and lower halves
2. A vertical center line (D1) that equally divides the blade into left and right halves

Both of these lines intersect at the center of the central hole 11. The bending line 400 originates from one side of the side groove 50 and extends into a portion of the R2 region below the R1 region. This design ensures that the bending is not limited to the R1 region but also incorporates part of the R2 region, enhancing the blade's overall functionality.

This design feature serves a specific purpose. As shown in FIG. 2, when viewed from the side, the height of the lifting part 40 gradually increases towards the outer edge of the blade. This progressive increase in height results in a unique airflow pattern during blade rotation. Specifically, it causes the volume of air displaced by the blade to increase as it moves towards the blade's outer edge. This graduated displacement of air enhances the formation of a stronger whirling wind, improving the blade's overall performance.

However, it's important to note that the extent of bending in the R2 region is carefully controlled. Excessive bending of the blade body in the R2 region could result in an overly large lifting part 40, which might create undesirable resistance during blade rotation. To mitigate this, the preferred embodiment limits the bending to a small portion of the R2 region. Specifically, only the end portion of the bending line 400, which originates from the side groove 50 in the R1 region, extends into the R2 region. This design optimization balances the benefits of the lifting part with the need to minimize rotational resistance.

During blade rotation, the lifting part 40 serves a crucial function in the mowing process. It generates a whirling wind that lifts flattened grass beneath the blade. This lifting action is a result of the lifting part's bent configuration, which displaces air in the direction of blade rotation. The resulting whirling wind serves multiple purposes: 1) It raises flattened grass, orienting it vertically. 2) The now-vertical grass is then cut by the side edge 30 of the blade. 3) Finally, the cut grass clippings are propelled upward by the same whirling wind.

This multi-step process enhances the overall efficiency and effectiveness of the mowing operation.

In the context of lawn mower design, three key factors are crucial for optimal performance: 1) The cutting power of the blade, 2) The ability to lift flattened grass into a vertical position, 3) The effective generation of upward airflow to efficiently discharge cut grass clippings This blade design addresses all three factors.

Particularly, the lifting part creates an upward air current that not only raises flattened grass but also facilitates the efficient upward discharge of grass clippings after cutting. This upward airflow is crucial in preventing clogging and ensuring clean ejection of cut grass, thereby enhancing overall mowing efficiency.

During blade rotation, the lifting part 40 serves a crucial function in the mowing process. It generates a whirling wind that lifts flattened grass beneath the blade. This lifting action is a result of the lifting part's bent configuration, which displaces air in the direction of blade rotation. The resulting whirling wind serves multiple purposes in the mowing operation. Firstly, it raises flattened grass, orienting it vertically. The now-vertical grass is then cut by the side edge 30 of the blade. Finally, the same whirling wind propels the cut grass clippings upward, facilitating their efficient discharge from the mowing deck. This multi-step process, combining lifting, cutting, and discharging actions, significantly enhances the overall efficiency and effectiveness of the mowing operation.

In the context of lawn mower design, three key factors are critical for optimal performance: the cutting power of the blade, the ability to lift flattened grass into a vertical position, and the effective generation of upward airflow to efficiently discharge cut grass clippings. These factors work in concert to ensure efficient mowing operations.

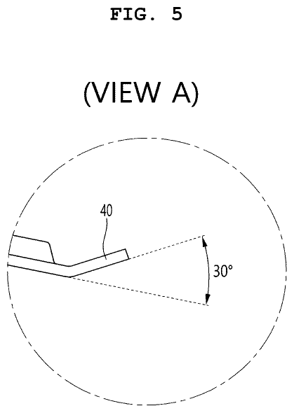

FIG. 5 illustrates the blade as viewed from perspective A, which is indicated in FIG. 3. Referring to FIG. 5, the lifting part 40 is bent or folded at an angle of approximately 30 degrees from the blade body. It's important to note that this bending angle can be adjusted based on various factors, including the performance requirements of the lawn mower and the overall dimensions of the blade (both length and width). This flexibility in design allows for optimization of the blade's performance for different lawn mower models and mowing conditions.

In the R2 region, located below the R1 region, a side edge 30 is formed with a length of B. This side edge 30 features a sharp surface designed to cut the grass that has been lifted into a vertical position during blade rotation. While a length (B) of 200 mm or more for the side edge 30 is generally preferred, the actual dimensions can be adjusted based on the overall length and width of the blade. This flexibility in the side edge's design allows for optimization of the cutting surface area relative to the blade's size and the specific mowing requirements.

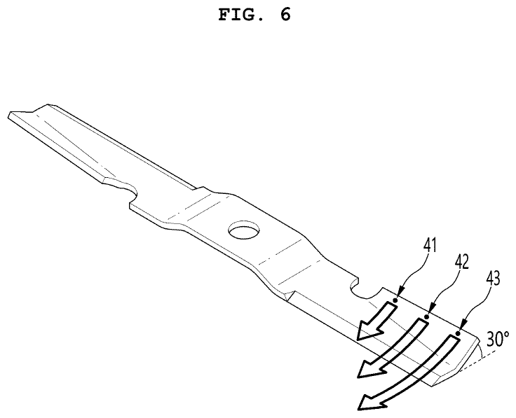

FIG. 6 provides a schematic illustration of the air movement generated by the lifting part in the blade of this embodiment. This diagram is crucial for understanding how the blade design contributes to both the cutting process and the efficient discharge of cut grass clippings.

As previously described, the lifting part 40 exhibits a progressive increase in height as it extends away from the side groove 50. This can be observed by comparing three positions (41, 42, 43) on the lifting part, each progressively further from the side groove 50. From position 41 to position 43, the height of the lifting part 40 gradually increases. This height variation is a result of the bending line 400 not being parallel to the blade's horizontal center line (D2). Consequently, the height of the lifting part 40 increases as it moves further from the side groove 50. This design feature has significant implications for air movement, as the volume of air displaced varies along different sections of the lifting part 40. The increasing height towards the outer edge of the blade allows for greater air displacement in that region, creating a more powerful whirling effect.

This design optimization ensures rapid generation of a strong whirling wind, which effectively lifts flattened grass and efficiently discharges cut grass clippings upward. The graduated air displacement enhances the blade's overall performance in both cutting and clipping removal processes.

What is claimed is:

1. A lawn mower blade comprising:
a convex center part with a central hole formed where a bolt can be fastened from below;
a curved part formed on both sides of the convex center part and bent downward;
a blade body extending from both sides of the curved part;
a side edge formed on the blade body with a sharp surface for cutting grass; and
a lifting part formed by bending or folding a portion of the blade body to protrude to a certain height and create whirling wind.

2. The lawn mower blade of claim 1,
wherein the blade has a centrally symmetric shape with the central hole of the convex center part as the origin.

3. The lawn mower blade of claim 1,
wherein when drawing an imaginary horizontal center line (D2) that equally divides the upper and lower parts of the blade based on the center of the central hole, and a vertical center line (D1) that equally divides the left and right sides of the blade, a bending line, which is the part where the lifting part is folded from the blade body is formed not parallel to the horizontal center line.

4. The lawn mower blade of claim 3,
wherein when the blade is viewed in plan, the upper right of the central hole is defined as the R1 region, the lower right of the central hole as the R2 region, the upper left of the central hole as the L1 region, and the lower left of the central hole as the L2 region by the horizontal center line and vertical center line,
the side groove and lifting part are formed in the R1 region and L2 region, and
part of the lifting part is also formed in the R2 region and L1 region.

5. The lawn mower blade of claim 4,
wherein among the inner surfaces of the side groove, a first inner surface is positioned at the same height as the blade body, and due to the bending of the lifting part, a second inner surface among the inner surfaces of the side groove is positioned slightly higher than the blade body.
